(19) United States
(12) Patent Application Publication
(10) Pub. No.: US 2004/0123146 A1
(43) Pub. Date: Jun. 24, 2004

(54) Security objects with language translation and speech to text conversion

(75) Inventors: Maria Azua Himmel, Yorktown Heights, NY (US); Herman Rodriguez, Austin, TX (US); Newton James Smith JR., Austin, TX (US); Clifford Jay Spinac, Austin, TX (US)

Correspondence Address: The Biggers Law Firm, 2608 Mason Street, Houston, TX, 77006, US

(73) Assignee: INTERNATIONAL BUSINESS MACHINES CORPORATION, Armonk, NY

(21) Appl. No.: 10/324,503

(22) Filed: Dec. 19, 2002

(51) Int. Cl. H04L 9/00; G06F 15/16

(52) U.S. Cl. 713/201; 709/229

(57) ABSTRACT

Controlling access to a resource including creating a security object in dependence upon user-selected security control data types, the security object comprising security control data and at least one security method, the security control data including a security control password in a security control language; receiving a request for access to the resource; receiving security request data, the security request data including a security request password in a security request language, the security request language being a language other than the security control language; and determining access to the resource in dependence upon the security control data and the security request data. Embodiments include converting a security request password from speech to text. Embodiments include translating a security request password from the security request language to the security control language.

### BACKGROUND OF THE INVENTION

1. Field of the Invention

The present invention relates to data processing methods, apparatus, systems, and computer program products therefor, and more particularly to methods, apparatus, systems, and computer program products in support of securing valid authentication and authorization for access to computer resources and other items.

2. Description of Related Art

It is common to use passwords to control access to resources, including everything from documents, to bank accounts, burglar alarms, automobiles, home security systems, personal video recorders, and so on. Passwords often consist of text strings that a user must provide to a security system in order to obtain access to a secured resource. A password provided by a user typically is checked against a stored password to determine a match. If the entered password and the stored password match, access is granted to the resource.

Mechanisms for managing passwords typically are programmed into the software applications with which the passwords are associated. That is, a program external to the password is used to authenticate the password, check to see if the password is about to expire, and determine the access granted. Systems securing resources therefore typically have password management operations coded into them to process and authenticate a specific type of password content. Users have no control over how passwords are defined or used in typical systems securing resources. Moreover, changing the way in which a password is used typically requires changing program code in a system securing resources.

In addition, such systems generally are capable of accepting and administering security with respect only one type of password and in only one language. If passwords are viewed as one type of security control data, then such systems can be said to function with only one kind of security control data. There is no way in such systems for anyone, especially not a user, to change the language of a password without substantial redesign and recoding. There is no way in such systems for anyone, especially not a user, to change from a password to some other kind of security control data without substantial redesign and recoding. There is no way in such system for a user or anyone else to determine to use more than one kind of security control data without substantial redesign and recoding. It would be beneficial to have improved ways of choosing and using security control data to secure resources through computer systems.

### SUMMARY OF THE INVENTION

Embodiments of the present invention provide means and methods for controlling access to resources, creating a security object in dependence upon user-selected security control data types, the security object comprising security control data and at least one security method, the security control data including a security control password in a security control language. Methods according to embodiments of the present invention typically include receiving a request for access to the resource and receiving security request data. In many embodiments of the present invention, the security request data includes a security request password in a security request language, the security request language being a language other than the security control language. Typical embodiments include determining access to the resource in dependence upon the security control data and the security request data.

In typical embodiments of the present invention, creating a security object includes storing in the security object a resource identification for the resource; storing in the security object user-selected security control data types, including a security control data type for a password with language translation; and storing, in the security object, security control data for each user-selected security control data type, including the security control password and an identification of the security control language. In many embodiments of the present invention, storing security control data includes storing an identification of the security request language. In many embodiments of the present invention, storing security control data includes storing an indication whether the security request password comprises speech.

In typical embodiments, the security request password comprises speech and receiving security request data includes converting a security request password from speech to text. In typical embodiments, determining access to the resource includes translating a security request password from the security request language to the security control language.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIGS. 1a, 1b, and 1c set forth block diagrams depicting alternative exemplary data processing architectures useful in various embodiments of the present invention.

FIG. 1d sets forth a block diagram of automated computing machinery useful in client devices and servers according to various exemplary embodiments of the present invention.

FIG. 2 sets forth a data flow diagram depicting exemplary methods of controlling access to a resource, including creating a security object and receiving a request for access to a resource, and determining whether to grant access to the resource.

FIG. 2b sets forth a flow chart depicting a method of controlling access to a resource where the method includes receiving a security request password for language translation.

FIG. 3 sets forth a data flow diagram depicting an exemplary method of creating a security object.

FIG. 4 sets forth a class relations diagram including a security class and a security control class.

FIG. 5 sets forth a data flow diagram depicting exemplary methods of receiving requests for access to resources.

### DETAILED DESCRIPTION OF EXEMPLARY EMBODIMENTS

### Introduction

The present invention is described to a large extent in this specification in terms of methods for securing valid authentication and authorization for access to computer resources and other items. Persons skilled in the art, however, will recognize that any computer system that includes suitable programming means for operating in accordance with the disclosed methods also falls well within the scope of the present invention.

Suitable programming means include any means for directing a computer system to execute the steps of the method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit. The invention also may be embodied in a computer program product and stored on a diskette or other recording medium for use with any suitable data processing system.

Embodiments of a computer program product may be implemented by use of any recording medium for machine-readable information, including magnetic media, optical media, or other suitable media. Persons skilled in the art will immediately recognize that any computer system having suitable programming means will be capable of executing the steps of the method of the invention as embodied in a program product. Persons skilled in the art will recognize immediately that, although most of the exemplary embodiments described in this specification are oriented to software installed and executing on computer hardware, nevertheless, alternative embodiments implemented as firmware or as hardware are well within the scope of the present invention.

### Definitions

In this specification, the terms “field,” “data element,” and “attribute,” unless the context indicates otherwise, generally are used as synonyms, referring to individual elements of digital data. Aggregates of data elements are referred to as “records” or “data structures.” Aggregates of records are referred to as “tables” or “files.” Aggregates of files or tables are referred to as “databases.” Complex data structures that include member methods, functions, or software routines as well as data elements are referred to as “classes.” Instances of classes are referred to as “objects” or “class objects.”

“Browser” means a web browser, a communications application for locating and displaying web pages. Browsers typically comprise a markup language interpreter, web page display routines, and an HTTP communications client. Typical browsers today can display text, graphics, audio and video. Browsers are operative in web-enabled devices, including wireless web-enabled devices. Browsers in wireless web-enabled devices often are downsized browsers called “microbrowsers.” Microbrowsers in wireless web-enabled devices often support markup languages other than HTML, including for example, WML, the Wireless Markup Language.

“CORBA” means the Common Object Request Broker Architecture, a standard for remote procedure invocation first published by the Object Management Group (“OMG”) in 1991. CORBA can be considered a kind of object-oriented way of making “RPCs” or remote procedure calls, although CORBA supports many features that do not exist in RPC as such. CORBA uses a declarative language, the Interface Definition Language (“IDL”), to describe an object's interface. Interface descriptions in IDL are compiled to generate ‘stubs’ for the client side and ‘skeletons’ on the server side. Using this generated code, remote method invocations effected in object-oriented programming languages such as C++ and Java look like invocations of local member methods in local objects. Whenever a client program, such as, for example, a C++ program, acquires an object reference, decoded from a stringfied object reference, from a Naming Service, or as a result from another method invocation, an ORB creates a stub object. Since a stub object cannot exist without an object reference, and an object reference rarely exists outside a stub object, these two terms are often used synonymously. For the server side, a skeleton is generated by the IDL compiler. A developer derives from that skeleton and adds implementation; an object instance of such an implementation class is called a ‘servant.’ The generated skeleton receives requests from the ORB, unmarshalls communicated parameters and other data, and performs upcalls into the developer-provided code. This way, the object implementation also looks like a ‘normal’ class.

“CGI” means “Common Gateway Interface,” a standard technology for data communications of resources between web servers and web clients. More specifically, CGI provides a standard interface between servers and server-side ‘gateway’ programs which administer actual reads and writes of data to and from file systems and databases. The CGI interface typically sends data to gateway programs through environment variables or as data to be read by the gateway programs through their standard inputs. Gateway programs typically return data through standard output.

“Client device” refers to any device, any automated computing machinery, capable of requesting access to a resource. Examples of client devices are personal computers, internet-enabled special purpose devices, internet-capable personal digital assistants, wireless handheld devices of all kinds, garage door openers, home security computers, thumbprint locks on briefcases, web-enabled devices generally, and handheld devices including telephones, laptop computers, handheld radios, and others that will occur to those of skill in the art. Various embodiments of client devices are capable of asserting requests for access to resources via wired and/or wireless coupling, for data communications. The use as a client device of any instrument capable of a request for access to a resource is well within the present invention.

A “communications application” is any data communications software capable of operating couplings for data communications, including email clients, browsers, special purpose data communications systems, as well as any client application capable of accepting data downloads (downloads of security objects or resources, for example) via hardwired communications channels such as, for example, a Universal Serial Bus or ‘USB,’ downloads through wired or wireless networks, and downloads through other means as will occur to those of skill in the art. In typical embodiments of the present invention, communications applications run on client devices.

“DCOM” means ‘Distributed Component Object Model,’ an extension of Microsoft's Component Object Model (“COM”) to support objects distributed across networks. DCOM is part of certain Microsoft operating systems, including Windows NT, and is available for other operating systems. DCOM serves the same purpose as IBM's DSOM protocol, which is a popular implementation of CORBA. Unlike CORBA, which runs on many operating systems, DCOM is currently implemented only for Windows.

“HTML” stands for ‘HyperText Markup Language,’ a standard markup language for displaying web pages on browsers.

“HTTP” stands for ‘HyperText Transport Protocol,’ the standard data communications protocol of the World Wide Web.

A “hyperlink,” also referred to as “link” or “web link,” is a reference to a resource name or network address which when invoked allows the named resource or network address to be accessed. More particularly in terms of the present invention, invoking a hyperlink implements a request for access to a resource. Often a hyperlink identifies a network address at which is stored a resource such as a web page or other document. As used here, “hyperlink” is a broader term than “HTML anchor element.” Hyperlinks include links effected through anchors as well as URIs invoked through ‘back’ buttons on browsers, which do not involve anchors. Hyperlinks include URIs typed into address fields on browsers and invoked by a ‘Go’ button, also not involving anchors. In addition, although there is a natural tendency to think of hyperlinks as retrieving web pages, their use is broader than that. In fact, hyperlinks access “resources” generally available through hyperlinks including not only web pages but many other kinds of data and server-side script output, servlet output, CGI output, and so on.

“LAN” means local area network.

“Network” is used in this specification to mean any networked coupling for data communications among computers or computer systems. Examples of networks useful with the invention include intranets, extranets, internets, local area networks, wide area networks, and other network arrangements as will occur to those of skill in the art.

An “ORB” is a CORBA Object Request Broker.

“Resource” means any information or physical item access to which is controlled by security objects of the present invention. Resources often comprise information in a form capable of being identified by a URI or URL. In fact, the ‘R’ in ‘URI’ is ‘Resource.’ The most common kind of resource is a file, but resources include dynamically-generated query results, the output of CGI scripts, dynamic server pages, documents available in several languages, as well as physical objects such as garage doors, briefcases, and so on. It may sometimes be useful to think of a resource as similar to a file, but more general in nature. Files as resources include web pages, graphic image files, video clip files, audio clip files, and so on. As a practical matter, most HTTP resources are currently either files or server-side script output. Server side script output includes output from CGI programs, Java servlets, Active Server Pages, Java Server Pages, and so on.

“RMI,” or “Java RMI,” means ‘Remote Method Invocation,’ referring to a set of protocols that enable Java objects to communicate remotely with other Java objects. RMI's structure and operation is somewhat like CORBA's, with stubs and skeletons, and references to remotely located objects. In comparison with other remote invocations protocols such as CORBA and DCOM, however, RMI is relatively simple. RMI, however, works only with Java objects, while CORBA and DCOM are designed to support objects created in any language.

“Server” in this specification refers to a computer or device comprising automated computing machinery on a network that manages resources and requests for access to resources. A “security server” can be any server that manages access to resources by use of security objects according to the present invention. A “web server,” or “HTTP server,” in particular is a server that communicates with browsers by means of HTTP in order to manage and make available to networked computers documents in markup languages like HTML, digital objects, and other resources.

A “Servlet,” like an applet, is a program designed to be run from another program rather than directly from an operating system. “Servlets” in particular are designed to be run on servers from a conventional Java interface for servlets. Servlets are modules that extend request/response oriented servers, such as Java-enabled web servers. Java servlets are an alternative to CGI programs. The biggest difference between the two is that a Java servlet is persistent. Once a servlet is started, it stays in memory and can fulfill multiple requests. In contrast, a CGI program disappears after it has executed once, fulfilling only a single a request for each load and run. The persistence of Java servlets makes them generally faster than CGI because no time is spent on loading servlets for invocations after a first one.

A “URI” or “Universal Resource Identifier” is an identifier of a named object in any namespace accessible through a network. URIs are functional for any access scheme, including for example, the File Transfer Protocol or “FTP,” Gopher, and the web. A URI as used in typical embodiments of the present invention usually includes an internet protocol address, or a domain name that resolves to an internet protocol address, identifying a location where a resource, particularly a web page, a CGI script, or a servlet, is located on a network, usually the Internet. URIs directed to particular resources, such as particular HTML files or servlets, typically include a path name or file name locating and identifying a particular resource in a file system coupled through a server to a network. To the extent that a particular resource, such as a CGI file or a servlet, is executable, for example to store or retrieve data, a URI often includes query parameters, or data to be stored, in the form of data encoded into the URI. Such parameters or data to be stored are referred to as ‘URI encoded data.’

“URLs” or “Universal Resource Locators” comprise a kind of subset of URIs, wherein each URL resolves to a network address. That is, URIs and URLs are distinguished in that URIs identify named objects in namespaces, where the names may or may not resolve to addresses, while URLs do resolve to addresses. Although standards today are written on the basis of URIs, it is still common to such see web-related identifiers, of the kind used to associate web data locations with network addresses for data communications, referred to as “URLs.” This specification refers to such identifiers generally as URIs.

“WAN” means ‘wide area network.’ One example of a WAN is the Internet.

“World Wide Web,” or more simply “the web,” refers to a system of internet protocol (“IP”) servers that support specially formatted documents, documents formatted in markup languages such as HTML, XML (eXtensible Markup Language), WML (Wireless Markup Language), or HDML (Handheld Device Markup Language). The term “Web” is used in this specification also to refer to any server or connected group or interconnected groups of servers that implement a hyperlinking protocol, such as HTTP or WAP (the ‘Wireless Access Protocol’), in support of URIs and documents in markup languages, regardless of whether such servers or groups of servers are coupled to the World Wide Web as such.

### DETAILED DESCRIPTION

Embodiments of the present invention provide security objects for improving the administration of controlling access to secured resources. Embodiments of the present invention in particular provide improved methods and means for controlling access to secured resources through security objects providing language translation and speech to text conversion. More particularly, users may enter speech or text in a first language called a security request language, and a security object of the present invention can translate the speech or text into a second language called a security control language. To the extent that the data entry is speech rather than text, the security object can provide speech to text conversion. In this way, one or more security objects can provide access to a resource for two or more users who speak different languages. If a password in the security control language is set to ‘thank you,’ and a supported security request language is Spanish, then a user may enter or speak the word ‘gracias’ and still be authenticated because the word ‘gracias’ is Spanish for ‘thank you.’ Similarly, when the security control language is English, the password is ‘thank you,’ and the security request language is German, a security object of the present inventor can validate against ‘danke,’ spoken or typed.

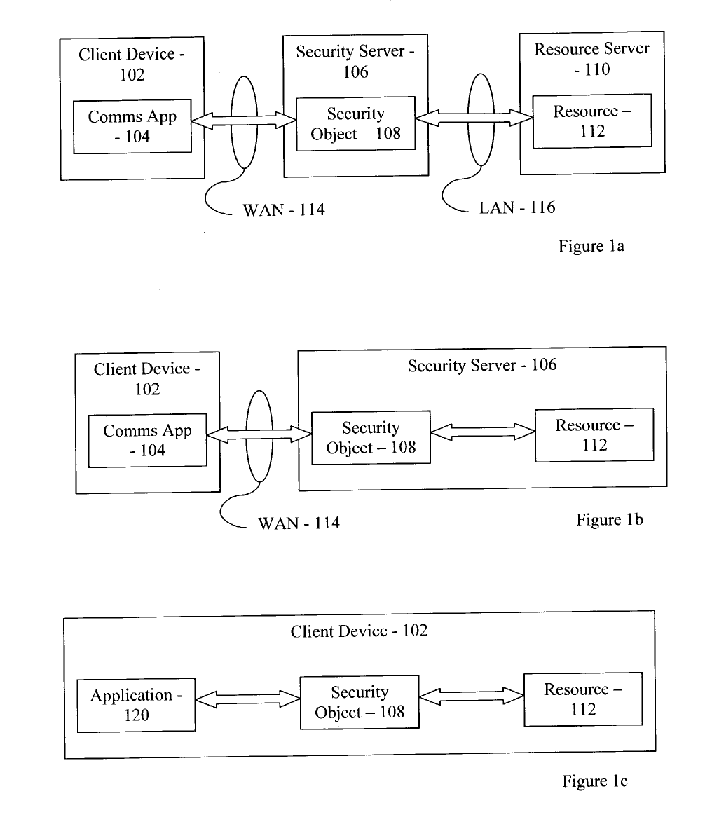

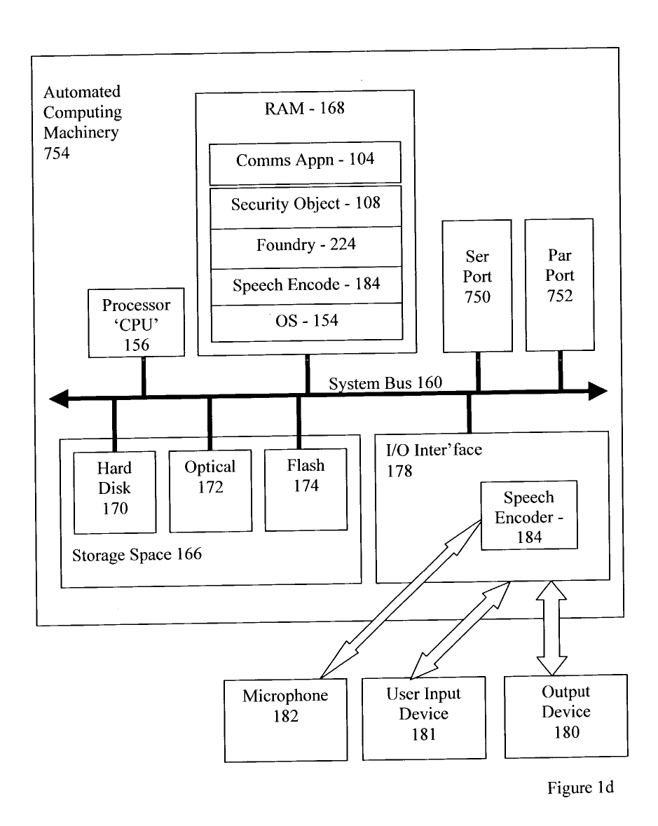

FIGS. 1a, 1b, and 1c set forth block diagrams depicting alternative exemplary data processing architectures useful in various embodiments of the present invention. As illustrated in FIG. 1a, some embodiments of the present invention deploy security objects (108) in security servers (106) coupled for data communications through LANs (116) to resource servers (110) upon which resources (112) are stored. Such embodiments typically are coupled for data communications to client devices (102) through networks such as WANs (114) or LANs (116). Data communications between client devices and security servers in such architectures are typically administered by communications applications (104), including, for example, browsers. WANs include internets and in particular the World Wide Web. Client devices (102) are defined in detail above and include any automated computing machinery capable of accepting user inputs through a user interface and carrying out data communications with a security server. A “security server” is any server that manages access to resources by use of security objects according to the present invention.

As illustrated in FIG. 1b, some embodiments of the present invention deploy security objects (108) in security servers (106) upon which are stored secured resources (112). The architecture of FIG. 1b illustrates that resources can be stored on the same server that secures access to the resources. In all this discussion, the term ‘security server’ refers to a server that manages access to resources by use of security objects according to the present invention. There is no limitation that a ‘security server’ as the term is used in this disclosure must provide other security services, or indeed that a security server must provide any security services whatsoever, other than managing access to resources through security objects. FIGS. 1a and 1b show security objects deployed in or upon security servers, but having security objects deployed upon it is not a requirement for a server to be considered a security server within the usage of this disclosure. Security objects may be deployed anywhere on a network or on client devices. If a server manages access to resources by use of security objects, regardless where the security objects are located, then that server is considered a ‘security server’ in the terminology of this disclosure. Some ‘security servers’ of the present invention, as described in more detail below, are ordinary web servers modified somewhat to support lookups in access control tables. Many ‘security servers’ of the present invention, however, are ordinary unmodified web servers or Java web servers, designated as ‘security servers’ only because they manage access to resources by use of security objects, security objects which may or may not be installed upon those same servers.

As shown in FIG. 1c, some embodiments deploy security objects (108) in client devices (102) which themselves also contain both the applications software (120) concerned with accessing the resources and also the resources (112) themselves. This architecture includes devices in which a security object maybe created on a more powerful machine and then downloaded to a less powerful machine. The less powerful machine then often is associated one-to-one with a single resource, or is used to secure a relatively small number of resources. One example of this kind of embodiment includes a garage door opener in which a security application program (120) is implemented as an assembly language program on a tiny microprocessor or microcontroller and the secured resource is a motor that operates a garage door. Another example is a briefcase fitted with a microprocessor or microcontroller, a fingerprint reader, and a USB port through which is downloaded a security object that controls access to a resource, an electromechanical lock on the briefcase.

Client devices and servers that are useful with various embodiments of the present invention typically comprise automated computer machinery (754) having elements such as those illustrated in FIG. 1d. FIG. 1d sets forth a block diagram of automated computing machinery (754) that includes a computer processor or ‘CPU’ (156). The exemplary automated computer machinery (754) of FIG. 1d includes random access memory (168) (“RAM”).

Stored in RAM in this example is a security object (108), which according to the exemplary architectures discussed above in connection with FIGS. 1a, 1b, and 1c, can be installed on a server or a client device. Also stored in RAM (168), in this example of useful automated computing machinery, is a communications application program (104) and an operating system (154). Examples of communications application programs useful with various embodiments of the invention include browsers. Examples of operating systems useful with various embodiments of servers and client devices according to the present invention include Microsoft's DOS, Microsoft's NT_{TM}, Unix, Linux, and others as will occur to those of skill in the art. The use of any operating system, or no operating system, is within the scope of the present invention. Also stored in RAM (168), in the example of FIG. 1d is a foundry (224) according to embodiments of the present invention.

In addition to RAM, the exemplary automated computer machinery (754) of FIG. 1d includes non-volatile computer memory storage space (166). Non-volatile storage space (166) can be implemented as hard disk space (170), optical drive space (172), electrically erasable programmable read-only memory space (so-called ‘EEPROM’ or ‘Flash’ memory) (174), or as any other kind of computer memory, as will occur to those of skill in the art, capable of receiving and storing software and computer data, including communications applications programs, security objects, operating systems, security control data, security request data, and resources comprising information in the form of computer data.

The automated computer machinery (754) of FIG. 1d includes an input/output interface (178) capable of providing output to output devices (180) and input from user input devices (181). Output devices include video screens on personal computers, liquid crystal screen on wireless handheld devices, audio speakers, television screens, and so on. Input devices and output devices both implement or utilize GUIs. Automated computer machinery (754) as illustrated in FIG. 1d typically includes also serial ports (750) and parallel ports (752) for additional input/output support. Input devices include mice, touch-sensitive screens, keyboards, and so on. An input device of particular usefulness in embodiments of the present invention is a microphone (182) for use in entering spoken passwords. In the exemplary automated computing machinery of FIG. 1d, input/output interface hardware (178) includes a speech encoder (184) for use in formulating speech entered through a microphone (182) into an encoding formats convenient for computer manipulation. Speech encoding hardware (184) is controlled in many embodiments of the present invention by speech encoding software (184) installed in RAM (168). An example of an encoding format for speech, useful with many embodiments of the present invention, is ‘MP3,’ the so-called ‘layer 3’ audio encoding standard for the encoding scheme known as ‘MPEG,’ a standard promulgated by the Motion Picture Experts Group. This reference to MP3 is explanatory, not limiting. Many useful encodings for speech will occur to those of skill in the art, and all of them are well within the scope of the present invention.

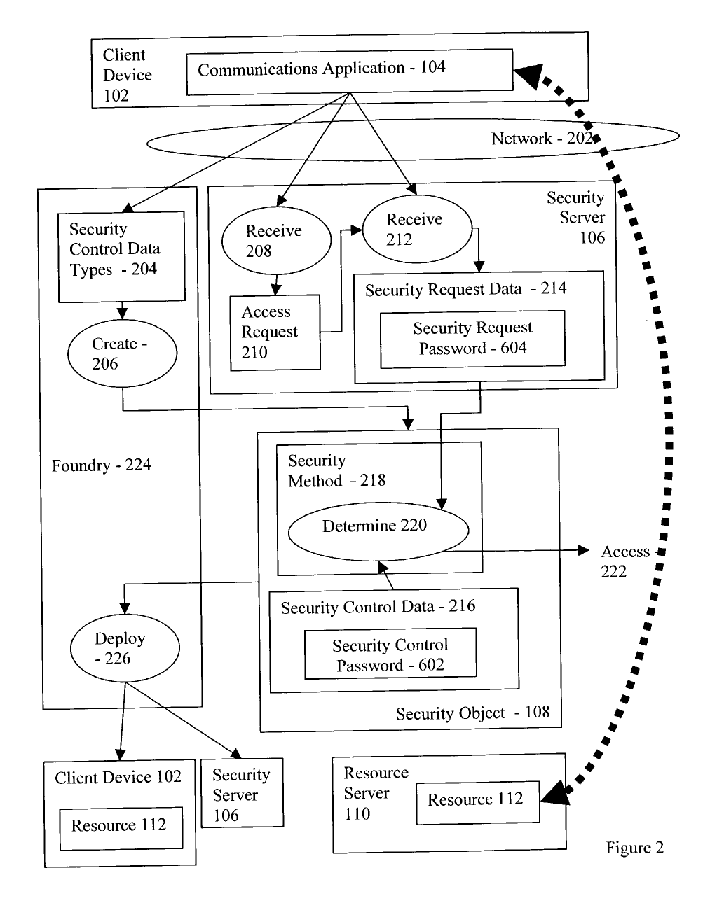

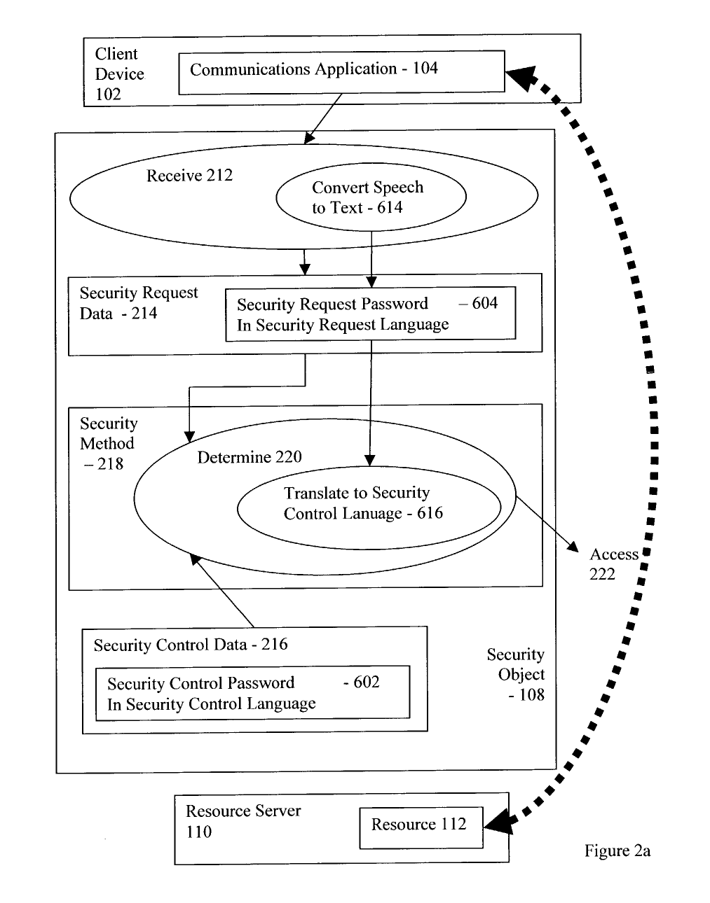

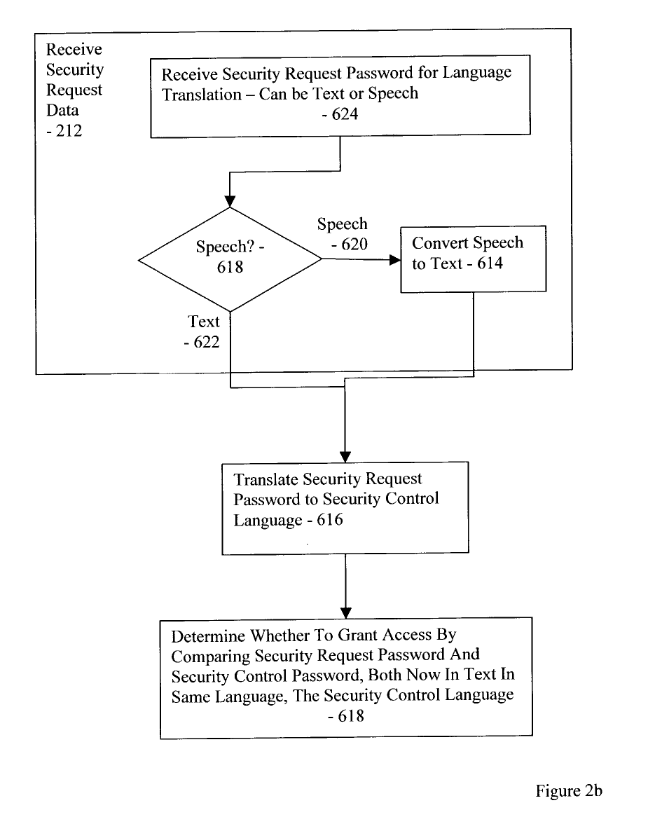

FIG. 2 sets forth a data flow diagram depicting an exemplary method of controlling access to a resource (112). The method of FIG. 2 includes creating (206) a security object (108) in dependence upon user-selected security control data types (204), the security object comprising security control data (216). In this disclosure, the application programs that administer the creation of security objects are called ‘foundries.’ In typical embodiments according to FIG. 2, a foundry (224) prompts a user through a user interface displayed on a client device (102) to select one or more security control data types through, for example, use of a menu similar to this one:

Please select a security control data type:

1. User Logon ID

2. Password

3. Password with Language Translation

4. Fingerprint

5. Voice Recognition

6. Retinal Scan

Your selection (1-6): ______

The foundry (224) creates (206) the security object (108) in dependence upon the user's selections of security control data types in the sense that the foundry aggregates into, or associates by reference, the security object security control data types according to the user's selection. If, for example, the user selects menu item 1 for a user logon ID, the foundry causes a security control data type to be included in the security object for administration of a user logon ID. If the user selects menu item 2 for a password, the foundry causes a security control data type to be included in the security object for administration of a password. If the user selects menu item 4 for a fingerprint, the foundry causes a security control data type to be included in the security object for administration of fingerprints. And so on for voice recognition technology, retinal scans, and any other kind of security control data amenable to administration by electronic digital computers.

In particular in the example of FIG. 2, the security control data (216) includes a security control password (602) in a security control language. The security control password is security control data within embodiments of the present invention. The security control language is the language in which the security control password is stored as security request data in a security object or security control object associated by reference with a security object. In this particular example, that is, of the exemplary method according to FIG. 2, in creating (206) a security object (108), a user has previously selected a security control data type of the kind exemplified by entry number 3 in the example menu above, “3. Password with Language Translation.”

In typical embodiments of the present invention, as shown in FIG. 2, a security object (108) includes at least one security method (218). In this disclosure, ‘security method’ means an object oriented member method. The security method typically is a software routine called for validating or determining whether to grant access to a resource and what level of authorization to grant. As discussed in more detail below, the security method can have various names depending on how the security object is implemented, ‘main( )’ for security objects to be invoked with Java commands, ‘security( )’ for servlets, and so on. These exemplary names are for clarity of explanation only, not for limitation. In many forms of security object, the name chosen for the security method is of no concern whatsoever.

Embodiments according to FIG. 2 include receiving (208) a request (210) for access to the resource and receiving a request for access to a resource can be implemented as a call to a security method in a security object. A security object implemented in Java, for example, can have a main( ) method called by invocation of the security object itself, as in calling ‘java MySecurityObject,’ resulting in a call to MySecurityObject.main( ). This call to main( ) is in many embodiments itself receipt of a request for access to the resource secured by use of the security object.

The method of FIG. 2 includes receiving (212) security request data (214). Continuing with the example of a security object called ‘MySecurityObject,’ the security object's member security method can prompt the user, or cause the user to be prompted, for security request data in dependence upon the security control data types in use in the security object. That is, if the security object contains security control data of type ‘User Logon ID,’ then the security method causes the user to be prompted to enter security request data, expecting the security request data received to be a user logon ID.

In the particular example of FIG. 2, the security request data (214) includes a security request password (604) in a security request language, the security request language being a language other than the security control language of the security control password (602). In this example, a security request password is security request data according to embodiments of the present invention. The security request language is the language in which the security request password is expressed. The security request language is typically a language other than the security control language in which the corresponding security control password is stored in a security object or in a security control object associated by reference with a security object. The security request password can be expressed in text, that is, in EBCDIC, ASCII, Unicode, or other encodings for text characters as will occur to those of skill in the art. Unicode is particularly useful with languages such as Chinese, Korean, and Japanese, whose characters need a graphical representation. Alternatively, the security request password may be expressed in speech and provided in a form such as, for example, an MP3 file, or other binary encodings of speech as will occur to those of skill in the art.

If the security object contains security control data of type ‘Password,’ for example, then the security method causes the user to be prompted to enter security request data, expecting the security request data received to be a password. If the security object contains security control data of type ‘Fingerprint,’ then the security method causes the user to be prompted to enter security request data, expecting the security request data received to be a digital representation of a fingerprint. The security method in such embodiments does not necessarily include in its prompt to the user any identification of the security control data type expected.

As described in more detail below, security objects typically associate by reference one or more security control objects having member methods that carry out actual security request data validation. Calls from a security object's security method to member methods in security control objects are what is meant by saying that a security method “causes” a user to be prompted for security request data.

The method of FIG. 2 includes determining (220) access (222) to the resource in dependence upon the security control data (216) and the security request data (214). More particularly, determining access means determining whether to grant access and what kind of access is to be granted. Generally in this disclosure, whether to grant access to a particular user is referred to as ‘authentication,’ and the kind of access granted is referred to as ‘authorization level.’ Determining whether to grant access typically includes determining whether security request data provided by a user in connection with a request for access to a resource matches corresponding security control data. That is, in the example of a password, determining whether to grant access includes determining whether a password provided as security request data matches a password stored in aggregation with a security object as security control data. In the example of a thumbprint, determining whether to grant access includes determining whether a thumbprint provided as security request data matches a thumbprint stored in aggregation with a security object as security control data. And so on. Authorization levels include authorization to read a resource, authorization to write to a resource (which typically includes ‘edit’ authority and ‘delete’ authority), and authorization to execute a resource (for which one ordinarily needs an executable resource).

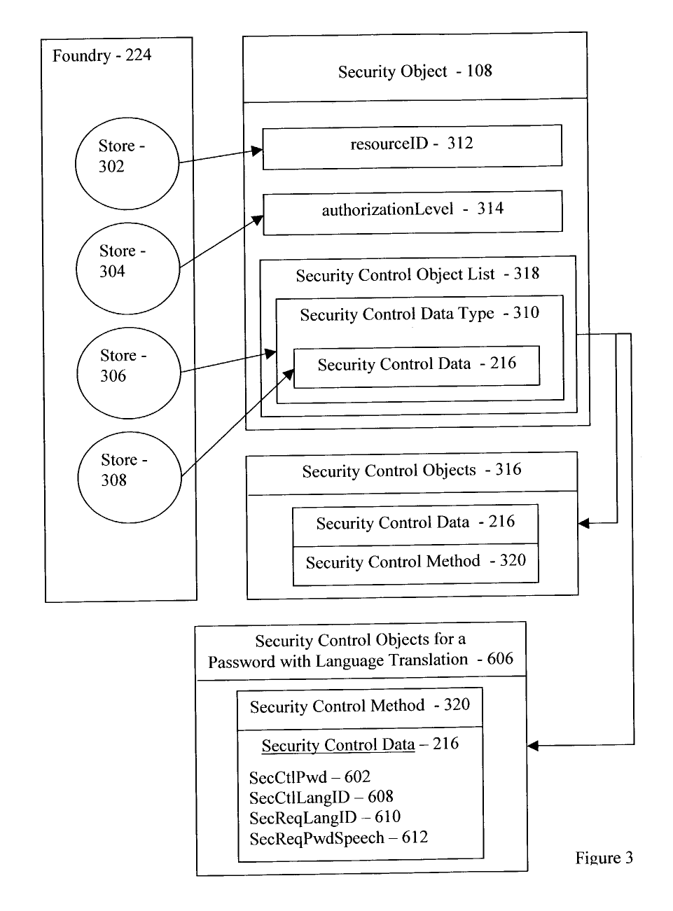

FIG. 2a is a data flow diagram depicting a method of controlling access to a resource according to exemplary embodiments of the present invention in which security request data (214) comprises a security request password (604) and receiving (212) security request data (214) includes converting (614) the security request password from speech to text. More particularly, in this kind method of embodiment, whether to provide for a spoken security request password is optional. Whether a security request password is provided in speech can be indicated in a data element in a pertinent security control object by a Boolean field such as, for example, the one named SecReqPwdSpeech (612) in the exemplary security object for a password with language translation (606) on FIG. 3. A validation function in such a security control object can be programmed, as described in more detail below, to check whether its security request password comprises speech, and, if it does, call a speech to text conversion routine before proceeding with translation.

The method of FIG. 2a includes determining (220) access to the resource, that is, determining whether to grant access (222) to the resource (112), and determining whether to grant access in the method of FIG. 2a includes translating (616) the security request password (604) from a security request language to a security control language. That is, translating the security request password means translating the security request password from the security request language in which the security request password is expressed into the security control language in which the corresponding security control password is stored, so that the two can be meaningfully compared. Translation is controlled by a security object, more particularly, by a security control object for a password with language translation associated by reference with a controlling security object. Such a security control object can provide storage for language identifications, such as, for example, the fields for storing respectively an identification of a security control language, SecCtILangID (608), and an identification of a security request language, SecReqLangID (610), in the exemplary security control object for a password with language translation (606) on FIG. 3.

Although it is typical for security control languages to be established when a security control object is created, whether to establish a security request language requirement at that time is optional. If a security request language is specified when a security object is created, then the security request object can be programmed either to treat the specified security request language as a default, prompting for a user to decide whether to accept the default or choose another security request language, or the security control object can be programmed always to use the specified security request language exclusively when one is provided. If no security request language is specified when a security object is created, then the security request object is left free to translate security request passwords into a security control language from any supported language whatsoever.

When its controlling security object is invoked with a request for access to a resource, a validation function in such a security control object can determine whether a security request language was specified by the user who instantiated the security control object through a foundry. If, for example, a field for identification of a security request language, such as SecReqLangID (610), remains null at run time, then no security request language has yet been specified, and the security control object can prompt a user to enter or choose a supported security request language from a list. If a security request language has been specified, the validation function can be programmed either to treat it as a requirement, that all security request passwords received in the security object will be required to be expressed in that security request language, or as a default, prompting the requesting user whether to take the default or choose some other security request language in which to express a security request password.

FIG. 2b sets forth a flow chart depicting a method of controlling access to a resource where the method includes receiving (624) a security request password for language translation. In the method of FIG. 2b, the security request password can be text or speech, and the method includes checking or determining whether the security request password is to be expressed in text or speech (618). If the security request password is expressed in speech (620), it is converted from speech to text (614) and then translated (616). If the security request password is expressed in text (622), processing proceeds directly to translating the security request password from its security request language to a corresponding security control language. A corresponding security control language, in this example, is a security control language identified in a data element for that purpose in the same security object or security control object in which the security request language is identified. In terms of the exemplary data structure at reference (606) in FIG. 3, the security control language identified in SecCtlLangID (608) is the ‘corresponding’ security control language for the security request language identified in SecReqLangID (610). After translating (616) the security request password into its corresponding security control language, both the security control password stored in a security object or associated security control object and the received security request password are now expressed in text in the same language, the security control language. Processing proceeds, in the example of FIG. 2b, by comparing (618) the two for a determination whether to grant access to a resource.

FIG. 3 sets forth a data flow diagram depicting an exemplary method of creating a security object. In other words, the method depicted in FIG. 3 drills down on what it means to create a security object in a foundry of the present invention. In the method of FIG. 3 creating a security object is shown to include storing (302) in the security object (108) a resource identification (312) for the resource. In other words, the foundry prompts the user to enter a filename, pathname, URI, URI, or any useful means as will occur to those of skill in the art for identifying a resource to be secured by the security object. In this example, the foundry then stores (302) the identification of the resource in a member field called ‘resourceID’ (312) in the security object itself.

In the method of FIG. 3 creating a security object includes storing (304) in the security object (108) an authorization level (314) of access for the resource. In other words, the foundry prompts the user to enter an authorization level, ‘read,’ ‘write,’ or ‘execute,’ for example, and then stores (304) the authorization level in a member field named ‘authorizationLevel’ (314) in the security object itself.

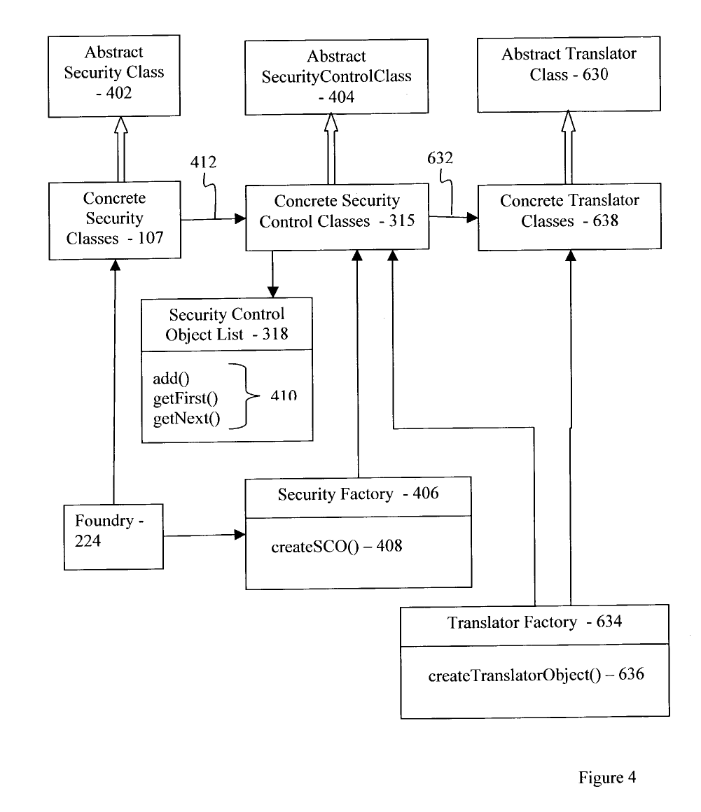

In the method of FIG. 3, creating a security object includes storing (306) in the security object (108) user-selected security control data types (310). More particularly, in the method of FIG. 3, security control data types (310) are stored as references to security control objects (316). Security control data types (310) in fact are security control classes (404 on FIG. 4) from which security control objects are instantiated. In the particular example of FIG. 3, storing (306) in the security object user-selected security control data types includes storing a security control data type for a password with language translation. In the example of FIG. 3, storing (306) in the security object (108) a security control data type for a password with language translation is carried out by storing a reference to a security contol object (606) designed and implemented through a foundry for translating and validating passwords.

In fact, storing (306) user-selected security control data types typically comprises storing references to security control objects (316) in a security control object list (318) in the security object (108), including instantiating a security control object (316) of a security control class in dependence upon security control data type. That is, if the security control data type is a password, then the foundry causes to be instantiated from a password security control class a password security control object, storing in the security control object list (318) a reference to the password security control object. Similarly, if the security control data type is a fingerprint, then the foundry causes to be instantiated from a fingerprint security control class a fingerprint security control object, storing in the security control object list (318) a reference to the fingerprint security control object. And so on.

The security control object list (318) itself is typically implemented as a container object from a standard library in, for example, C++ or Java. That is, the security control object list (318) is typically a class object aggregated by reference to the security object (108).

In the method of FIG. 3, creating a security object includes storing (308) in the security object security control data (216) for each user-selected security control data type (310). Instantiating a security control object (316) calls a constructor for the security control object. In some embodiments, it is the constructor that prompts for security control data of the type associated with the security control object. That is, if the security control data object is a password security control object, its constructor prompts for a password to be stored (308) as security control data (216). Similarly, if the security control data object is a thumbprint security control object, its constructor prompts for a thumbprint to be stored (308) as security control data (216). And so on.

In the example of the security object for a password with language translation of FIG. 3, storing (308), in the security object, security control data for each user-selected security control data type, includes storing security control data for a security control password (602) and an identification (608) of a security control language. The data structure at reference (606) on FIG. 3 is an exemplary data structure for a security control object for a password with language translation. The security control password is the form of the password to be used for validation. The security control password is entered by a user operating a foundry to create a security object to secure a resource. The security control password can be stored in a field in a security control object such as, for example, the field named ‘SecCtlPwd’ (602) in the exemplary security control object for a password with language translation at reference (606) on FIG. 3.

The security control password is merely raw computer data from the point of view of the security object or the security control object. It is useful therefore, for security objects and security control objects involved with language translation, to have an identification of the language in which the security control password is implemented. The identification of the security control language is a data element for that purpose, and can be implemented as a field in a security control object, such as, for example, the field named ‘SecCtlLangID’ (608) in the exemplary security control object for a password with language translation at reference (606) on FIG. 3.

In the example of the security object for a password with language translation of FIG. 3, storing (308), in the security object, security control data for each user-selected security control data type, optionally includes storing an identification of the security request language, such as, for example, the field SecReqLangID (610). If identification of the security request language is so stored when the security control object is created, then a validation function for the security control object can be programmed to proceed at run time with no need to prompt a user requesting access for the security request language. Alternatively, the validate function can treat the security request language identified at create time as a default and prompt a requesting user whether to take the default. If no security request language is identified at create time, then a validation function for a password with language translation prompts the requesting user at run time to identify the security request language in which the security request password is expressed.

In the example of the security object for a password with language translation of FIG. 3, storing (308), in the security object, security control data (216) for each user-selected security control data type, optionally includes storing an indication (612) whether the security request password comprises speech, such as, for example, the Boolean field SecReqPwdSpeech (612). In such an example, a validation function in the security object (108) on an associated security control object (606) can be programmed to convert a received security request password from speech to text if a field such as SecReqPwdSpeech (612) is set to ‘true.’

In architectures similar to those illustrated in FIGS. 1a and 1b in which a client device (102) is located remotely across a network (114) from a security server (106) upon which security control data is to be stored (308), the security control data advantageously is communicated across the network from the client device to the security server in encrypted form. One example of such encrypted communications is network messaging by use of ‘SSL,’ that is, communications connections through a ‘Secure Sockets Layer,’ a known security protocol for use in internet protocol (“IP”) networks, in which encryption of message packets is provided as a standard communications service. In addition to encrypted communications of security control data, at least some elements of security control data, such as, for example, passwords, also are advantageously stored (308) in encrypted form.

Even more particularly, foundries according to the present invention may be implemented and operated in accordance with the following pseudocode.

```
Class Foundry {
  private String selectionText =
    “Please select a security control data type:
      1. Password
      2. Password with Language Translation
      3. Fingerprint
      4. Voice Recognition
    Your selection (1-4):  ”
  void main( ) {
    //  create security object
    SecurityClass SO = new SecurityClass( );
    // identify resource secured by the new security object
    Resource resourceID =
      getResourceID(“Please enter resource ID:  ”);
    // store resource ID in security object
    SO.setResource(resourceID);
    // prompt for authorization level
    char authorizationLevel =
      getAuthorizationLevel(“Please enter authorization level:  ”);
    // store authorization level in security object
    SO.setAuthorizationLevel(authorizationLevel);
    // get a first ‘SCD-Type,’ Security Control Data Type
    SCD-Type = getUserSelection(selectionText);
    while(SCD-Type != null) {
      // based on SCD-Type, create Security Control Object
      SCO = SCD-Factory.createSCO(SCD-Type);
      // store security control data in the security control object
      SCO.setSecurityControlData( );
      // add new SCO to the list in the Security Object
      SO.add(SCO);
      // get another SCD-Type, as many as user wants
      SCD-Type = getUserSelection(selectionText);
    } // end while( )
  } // end main( )
} // end Foundry
```

With reference to FIGS. 2 and 3, the pseudocode foundry creates (206) a security object (108) by instantiating a security class:

SecurityClass SO=new SecurityClass( ).

The pseudocode foundry then stores (302) a resource identification (312) through:

Resource resourceID=getResourceID(“Please enter resource ID: ______”);

SO.setResource(resourceID);

The call to SO.setResource( ) is a call to a member method in the security object described in more detail below. The pseudocode foundry stores (304) an authorization level (314) through:

char authorizationLevel=getAuthorizationLevel(“Please enter authorization level: ______”);

SO.setAuthorizationLevel(authorizationLevel);

The call to SO.setAuthoriztionLevel( ) is a call to a member method in the security object described in more detail below.

The pseudocode foundry stores (306) security control data types (310) by repeated calls to SO.add(SCO). SO.add( ) is a member method in the security object that adds security control objects to a list in the security object as described in more detail below.

The pseudocode foundry stores (308) security control data (216) in the security object (108) by repeated calls to SCO.setSecurityControlData( ).

SCO.setSecurityControlData( ) is a member method in a security control object (316) that prompts for and stores a type of security data with which the security control object is associated, fingerprints for fingerprint security control object, passwords for password security control objects, and so on. A separate security control object is created for each security control data type selected or request by the user in response to getUserSelection(selectionText).

Each time the user selects a new security control data type, the foundry creates a new security control object by calling a factory method in a security control object factory. The security control object factory is a class called SCO-Factory, and the factory method is SCO-Factory.createSCO( ). The calls to SCO.setSecurityControlData( ) are polymorphic calls, each of which typically accesses a different security control object although exactly the same line of code is used for each such call. In this elegant solution, the foundry itself never knows or cares which security control data types are implemented or what security control data is stored in security objects it creates.

Readers of skill in the art may notice that the foundry could be made even leaner by allowing security control object constructors to carry out the work of SCO.setSecurityControlData( ). In this example, however, for clarity of explanation of the operation of the foundry, SCO.setSecurityControlData( ) is left at the foundry level so that the effects of foundry operations are more fully exposed by the foundry itself.

The process of creating security control objects can be carried out as illustrated in the following pseudocode factory class:

```
//
// Security Control Object Factory Class
//
// Defines a parameterized factory method for creating security control
objects
//
class SCO-Factory {
    public static SecurityControlClass createSCO(SCD-Type) {
        // establish null reference to new Security Control Object
        SecurityControlClass SecurityControlObject = null;
        switch(SCD-Type) {
            case LOGONID:
                SecurityControlObject = new
                LogonIDSecurityControlClass;
                break;
            case PASSWORD:
                SecurityControlObject = new
                PasswordSecurityControlClass;
                break;
            ... ... ... // Can have many security control data types,
                      // not merely these four
            case FINGERPRINT:
                SecurityControlObject = new
                FingerprintSecurityControlClass;
                break;
            case RETINA:
                SecurityControlObject = new
                RetinaSecurityControlClass;
                break;
        } // end switch( )
        return SecurityControlObject;
    } // end createSCO ( )
} // end class SCO-Factory
```

The factory class implements the createSCO( ) method, which is a so-called parameterized factory method. CreateSCO( ) accepts as a parameter the security control data type ‘SCD-Type’ of the security control data to be administered by a security control object. CreateSCO( ) then operates a switch( ) statement in dependence upon SCD-Type to decide exactly which security control class to instantiate depending on which type of security control data is needed—logon IDs, passwords, fingerprints, voice identifications, and so on. Although only four security control data types are illustrated in the factory class (logon IDs, passwords, fingerprints, and retinal scans), in fact the factory can create and return to the calling foundry a security control object for any type of security control data supported by the security system in which it is installed, that is, any type of security control object for which a security control data type or class (404) is defined.

Security control objects can be instantiated from a security control class according to the following pseudocode security control class:

//
// abstract SecurityControlClass
//
Abstract Class SecurityControlClass {

private String SecurityControlData;
public void setSecurityControlData( ) {

SecurityControlData =

prompt( “Please enter security control data: );

}
public boolean validate( ) {

SecurityRequestData =

prompt(“Enter Security request Data: ”);

if(SecurityControlData = = SecurityRequestData) return true;
else return false;

}

}

The pseudocode security control class depicts an object oriented ‘interface.’ In Java, such structures are literally known as ‘interfaces’ to be ‘extended’ by concrete classes. In C++, such structures are known as abstract base classes from which concrete subclasses inherit. Either way, the pseudocode security control class establishes a set of public member methods to be used by all security control objects. The pseudocode security control class provides string storage of security control data, which may work just fine for logon IDs and passwords, but will not work for fingerprints and voice recognition. Similarly, setSecurityContolDate( ) and validate( ) will be implemented differently for different types of security control data.

The member fields and member methods of the pseudocode security control class form an interface that is fully expected to be overridden in subclasses from which security control objects are instantiated, although all subclasses are required to implement in some fashion the public member fields and public member methods of the abstract base class, the security control class. Here, beginning with a concrete security control class for logon IDs, are several examples of concrete security control classes from which practical security control objects are instantiated by the factory method SecurityControlClass.createSCO( ).

//
// concrete security control class for logon IDs
//
Class LogonIDSecurityControlClass : SecurityControlClass {

private String SecurityControlData;
public void setSecurityControlData( ) {

SecurityControlData =

prompt( “Please enter security control data: );

}
public boolean validate( ) {

SecurityrequestData =

prompt(“Enter Security request Data: ”);

if(SecurityControlData = = SecurityrequestData) return true;
else return false;

}

}

The LogonIDSecurityControlClass appears almost identical to its parent SecurityControlClass, but it is important to remember that LogonIDSecurityControlClass, unlike its abstract parent, defines a class that can actually be instantiated as a security control object for determining access to resources on the basis of entry of a valid logon ID. The following pseudocode security control class for fingerprints illustrates how security control classes differ across security control data types.

```
//
//  concrete security control class for fingerprints
//
Class FingerprintSecurityControlClass : SecurityControlClass {
  private File SecurityControlData;
  public void setSecurityControlData( ) {
    SecurityControlData =
        prompt( “Please enter security control data:  );
  }
  public boolean validate( ) {
    FILE SecurityrequestData =
      prompt(“Enter Security request Data:  ”);
    if((bitwiseCompare(SecurityControlData,
    SecurityrequestData))!=true)
      return true;
    else return false;
  }
}
```

In FingerprintSecurityControlClass, SecurityControlData is in a file rather than a string. Similarly, the prompt( ) function in the validate( ) method expects the user to provide a fingerprint file in response to the prompt for security control data. In addition, the bitwiseCompare( ) method, although not shown, is implemented to open both files, compare them bit by bit, and ultimately deny access to a resource if the comparison fails.

A concrete security control class for passwords with language translation can be implemented as illustrated by the following pseudocode example:

```
//
//  concrete security control class for passwords with language translation
//
Class PwdLangTransSecurityControlClass : SecurityControlClass {
  private String SecCtlPwd;
  private String SecCtlLangID;
  private String SecReqPwd;
  private String SecReqLangID = null;
  private boolean SecReqPwdSpeech = false;
  // called by foundry, alternatively constructor for this
  public void setSecurityControlData( ) {
    SecCtlPwd = prompt( “Please enter password:  ”);
    SecCtlLangID = prompt( “Please enter security control language:  ”);
    // security request language may be left null
    SecReqLangID = prompt(“Please enter security request language:
    ”);
    SecReqPwdSpeech = prompt(“Is password to be spoken? (Y/N):  ”);
  }
  public boolean validate( ) {
    if(SecReqLangID == null)
      SecReqLangID = prompt(“Please enter security request
      language:  ”);
    SecReqPwd = prompt(“Password:  ”);
    if(SecReqPwdSpeech) {
      File aSpeechFile = prompt(“Please speak the password.”);
      SecReqPwd = speechToText(aSpeechFile);
    }
    else SecReqPwd = prompt(“Password:  ”);
    // password is still in security request language
    // now translate it to security control language
    TranslatorClass aTranslator =
      TranslatorFactory.createTranslator(SecCtlLangID,
      SecReqLangID);
    SecReqPwd == aTranslator.translate(SecReqPwd);
    // validate by comparing the security request password
    // and the security control password, both now in text
    // and both now in the security control language
    if((c = stringCompare(SecCtlPwd, SecReqPwd)) == true)
      return true;
    else return false;
  } // end validate( )
} // PwdLangTransSecurityControlClass
```

The concrete security contol class for passwords with language translation implements the interface from the abstract SecurityontrolClass by defining two member methods from the abstract class. The concrete class defines ‘setSecurityControlData( ),’ for setting security control data elements which in this example include string storage ‘SecCtlPwd’ for a security control password, string storage ‘SecCtlLangID’ for an identification of a security control language, string storage ‘SecReqLangID’ for an identification of a security request language, and a Boolean indication ‘SecReqPwdSpeech’ whether the security request password is to be speech, ‘true’ for speech, ‘false’ for text. In this example, the prompt for the security request language ID is programmed to permit a null response. That is, a user of a foundry may tap the ‘enter’ key to step past the prompt for a security request language and return a null entry without error.

The second member method implementing the interface from the abstract SecurityControlClass is ‘validate( ),’ for validating security request data which in this example comprises a security request password for language translation, ‘SecReqPwd.’ Validate( ) begins by checking whether a security request language was specified when its security request object was instantiated and, if not, prompting for one:

```
if(SecReqLangID == null)
    SecReqLangID = prompt(“Please enter security request language:
    ”);
SecReqPwd = prompt(“Password:  ”);
```

Validate( ) proceeds by determining whether its security request password is to be provided as speech. If the security request password is to be speech, validate( ) prompts for it and translates it:

```
if(SecReqPwdSpeech) {
    File aSpeechFile = prompt(“Please speak the password.”);
    SecReqPwd = speechToText(aSpeechFile);
}
```

If the security request password is to be text rather than speech, validate( ) prompts for it:

else SecReqPwd=prompt(“Password: ______”);

Now, regardless whether the security request password was provided as speech or text, validate( ) has its security request password in text form. Validate( ) proceeds to translate the password. Validate( ) translates the password by use of a translator object instantiated for validate( ) by a parameterized factory method in a translator factory. The translator factory is a class named ‘TranslatorFactory.’ The factory method is ‘createTranslator( ).’ And the parameters are the language in which the security request password is originally expressed, SecReqLangID, and the language into which the security request password is to be translated, SecCtlLangID. The function createTranslator( ) instantiates a translator object for translating the particular security request language into the particular security control language and returns a reference to it:

// password is still in security request language
// now translate it to security control language
TranslatorClass aTranslator =
TranslatorFactory.createTranslator(SeCReqLangID, SeeCtlLangID);

Validate( ) carries out the translation by calling a translator method in the translator object, a Translator.translate(SecReqPwd), which takes as a parameter a security request password in the security request language and returns the security request password translated to the security control language:

SecReqPwd=a Translator.translate(SecReqPwd);

The call to the translate( ) method is not parameterized with language identifications. The call to aTranslator.translate(SecReqPwd) is polymorphic, retaining exactly, precisely the same form for any combination of languages, French to Japanese, Chinese to Swahili, English to German, and so on, for any supported combination of languages.

After translating the security request password, when both the security request password and the security control password now in the same security control language, validate( ) proceeds to determine whether to grant access by comparing the text strings for the security request password and the security control password. If they match, validate( ) return ‘true,’ otherwise ‘false’:

if((c = stringCompare(SecCtlPwd, SecReqPwd)) == true)
return true;
else return false;

Translator objects for various combinations of security request language and security control language can be created as illustrated by the following exemplary pseudocode translator factory class:

```
//
//  Translator Factory Class
//
//  Defines a parameterized factory method for creating translator objects
//
class TranslatorFactory {
  public static TranslatorClass createTranslatorObject(
              SecReqLangID, SecCtlLangID) {
    // establish null reference to new translator object
    TranslatorClass aTranslatorObject = null;
    switch(SecReqLangID) {
      case SPANISH:
        switch(SecCtlLangID) {
          case ENGLISH:
            aTranslatorObject = new SpanishEnglishTranslatorClass;
            break;
          case JAPANESE:
            aTranslatorObject = new SpanishJapaneseTranslatorClass;
            break;
          } // end switch( )
      break; // end case SPANISH for security request language
      case GERMAN:
        switch(SecCtlLangID) {
          case ENGLISH:
            aTranslatorObject = new GernamEnglishTranslatorClass;
            break;
          case JAPANESE:
            aTranslatorObject = new
                GermanJapaneseTranslatorClass;
            break;
          } // end switch( )
      break; // end case GERMAN for security request language
      case FRENCH:
        switch(SecCtlLangID) {
          case ENGLISH:
            aTranslatorObject = new FrenchEnglishTranslatorClass;
            break;
          case JAPANESE:
            aTranslatorObject = new FrenchJapaneseTranslatorClass;
            break;
          } // end switch ( )
      break; // end case FRENCH for security request language
    } // end switch ( )
    return aTranslatorObject;
  } // end createTranslatorObject( )
} // end class TranslatorFactory
```

The exemplary pseudocode translator factory class implements the createTranslatorObject( ) method, a parameterized factory method. CreateTranslatorObject( ) accepts two parameters, SecReqLangID and SecCtlLangID, identifying the security request language and the security control language respectively. CreateTranslatorObject( ) then operates a series of imbedded switch( ) statement in dependence upon SecReqLangID and upon SecCtlLangID to decide exactly which concrete translator class to instantiate depending on the security control language and the security request language.

The exemplary pseudocode translator factory class supports instantiation of translator objects for translating the security request languages of Spanish, German, and French into the security control languages of Japanese and English. That is, the exemplary pseudocode translator factory class supports translation in the following combinations of languages:

Spanish to English,

Spanish to Japanese,

German to English,

German to Japanese,

French to English, and

French to Japanese.

These six combinations of languages are merely exemplary, not limiting. Any combination of languages is well within the scope of the present invention as are translator factories supporting them.

An exemplary abstract class can be declared as follows:

//
// abstract translator class
//
Abstract Class TranslatorClass {
public String translate(String SecReqPwd);
}

The abstract translator is not instantiated. It declares an interface for inheritance by concrete translator classes, in support of polymorphic calls to the translator( ) method declared in this example as an interface method. An example of a concrete translator class for translation from Spanish to English is:

```
//
// concrete translator class - Spanish to English
//
Class SpanishEnglishTranslatorClass:TranslatorClass {
  private String aSecReqPwd;
  public String translate(String SecReqPwd) {
    // call Spanish to English language translation engine
    // translate SecReqPwd from Spanish to English
    // store translation in aSecReqPwd
    return aSeqReqPwd;
  }
}
```

An example of a concrete translator class for translation from Spanish to Japanese is:

```
//
// concrete translator class - Spanish to Japanese
//
Class SpanishEnglishTranslatorClass:TranslatorClass {
  private String aSecReqPwd;
  public String translate(String SecReqPwd) {
    // call Spanish to Japanese language translation engine
    // translate SecReqPwd from Spanish to Japanese
    // store translation in aSecReqPwd
    return aSeqReqPwd;
  }
}
```

This disclosure makes no representation that pseudocode examples can be compiled or executed. Nevertheless, at this point in this disclosure, how to make and use translator objects in embodiments of the present invention is clear to persons of skill in the art. That fact that this disclosure sets forth only two examples of concrete translator classes is not limiting. Persons of skill in the art will design and implement many translator classes for many combinations of languages, and all of them are well within the scope of the present invention.

Security objects themselves can be implemented, for example, according to the following pseudocode security class.

```
//
// SecurityClass ...
// a class from which security objects can be instantiated
//
Class SecurityClass
{
  private Resource aResourceID;
  public void setResourceID(resourceID) {
    aResourceID = resourceID
  }
char anAuthorizationLevel;
public void setAuthorizationLevel(authorizationLevel) {
  anAuthorizationLevel = authorizationLevel
}
// list of security control objects (references, actually)
private List aList = new List( );
// method for adding Security Control Objects to the List
public void add(SCO) {
  aList.add(SCO);
}
// validate requests for access against all SCOs in the list
public boolean main( )
{
  SCO = aList.getFirst( );
  while(SCO != null)
  {
    if((SCO.validate( )) != true) {
      denyAccess( );
      return false;
    }
    SCO = aList.getNext( );
  }
  // all SCOs in the List are now validated
  grantAccess(anAuthorizationLevel);
    return true;
  } // end validate( )
} // end SecurityClass
```

The security class provides a storage location for a resource identification (312) named ‘resource ID,’ as well a member method named setResourceID( ) for storing (302) the resource identification. Similarly, the security class provides a field for authorization level and a method for storing (304) authorization level. The exemplary pseudocode security class provides storage in the form of a list for storing security control objects. In C++, it would be possible to store security control objects as such, but in typical embodiments, the list is used to store security control objects as references.

The security class includes a method, addSCO( ) for adding a security control object to the list. The methods aList.add( ), aList.getFirst( ), and aList.getNext( ) are member methods in a list object that effectively operate a list object as an iterator. An ‘iterator’ is a conventional object oriented design pattern that supports sequential calls to elements of an aggregate object without exposing underlying representation. In this example, main( ) assumes that aList.getNext( ) returns null upon reaching the end of the list. It is common also, for example, for list classes to support a separate member method called, for example, ‘isDone( ),’ to indicate the end of a list. Any indication of the end of a list as will occur to those of skill in the art is well within the scope of the present invention.

In addition, the exemplary pseudocode security class includes a member method, main( ), that validates security request data in turn for each security control object in the list. In this particular example, the validation method is called ‘main( )’ to support implementing security objects in Java, so that the validation method can be called by a call to the object name itself. On the other hand, when SecuritClass is implemented as a Java servlet, there is no requirement for a member method named ‘main( ),’ because, although servlets also are invoked by use of the class name itself, the interior interface requirements for servlets are different. When SecurityClass is implemented as a Java servlet, therefore, the name of the member method ‘main( )’ is changed to implement a member method signature from the standard Java servlet interface, such as, for example:

public void service(ServletRequest req, ServletResponse res).

The validation method main( ) operates by obtaining from the list each security control object in turn and calling in each security control object the interface member method ‘validate( ).’ As described in detail above, the validate( ) method in each security control object prompts for security request data, compares security request data to security control data, and return true or false according to whether the comparison succeeds or fails. SecurityClass.main( ) operates by denying access and returning false if validation fails for any security control object in the list. SecurityClass.main( ) grants access and return true if validation succeeds for all security control objects in the list.

If SecurityClass.main( ) grants access, the access granted has the authorization level set by the member method setAuthorizationLevel( ). More particularly, in the method of FIG. 2, determining (220) access (222) includes authorizing a level of access in dependence upon the authorization level of access for the resource (314 on FIG. 3). In the example of security objects implemented to accept calls from hyperlinks in web pages displayed in browsers on client devices located remotely across a network, the security objects themselves often are implemented as servlets or CGI programs that administer HTTP GET and PUT request messages. In such exemplary embodiments, a security object granting access to a resource having only ‘read’ authorization level would honor a GET request by transmitting to the client browser a copy of the resource in HTML. The same exemplary security object, however, would not honor a PUT request for writing data to the resource.

FIG. 4 sets forth a class relations diagram summarizing exemplary relations among classes and objects useful in various embodiments of the present invention. As shown in FIG. 4, in many embodiments, concrete security classes (107), from which security objects are instantiated, are subclasses that inherit from abstract security classes (402). Similarly, concrete security control classes (315), from which security control objects are instantiated, are subclasses that inherit from abstract security control classes (404). And concrete translator classes (638), from which translator objects are instantiated, are subclasses that inherit from abstract translator classes (630).

In addition, it is useful to remember that ‘abstract,’ as the term is used here to describe classes, is used in support of interface definition, in a fashion similar to its use in the terminology of C++. In Java, structures that here are called abstract classes would be called ‘interfaces,’ as such. No doubt such structures have other names in other environments, but here they are called ‘abstract classes’ and used to illustrate declarations of object oriented interfaces.

Foundries (224) are shown in FIG. 4 as classes having references to factory classes (406) and concrete security classes (107). Foundries (224), as described in detail above, cooperate with factories (406) and security objects instantiated from concrete security classes (107) by passing to security objects references to security control objects for inclusion in security control object lists (318). The arrow (412) can be drawn between security classes (107) and security control classes (315), indicating that a security class ‘has a’ security control class, because the reference needed to implement the object oriented ‘has a’ relationship is provided to the security class by a foundry (224) for storage in a security control object list (318).

Security control object lists (318) are often implemented as container objects from a standard library in, for example, C++ or Java. That is, a security control object list (318) is typically a class object aggregated by reference to a security object instantiated from a security class (107). With member methods (410) such as add( ), getFirst( ), and getNext( ), a security control object list (318) often can function as a so called ‘iterator,’ greatly easing manipulation of security control objects on behalf of a security object. Iterator operations are illustrated in the pseudocode above for SecurityClass. Persons of skill in the art will recognize that, although references to security control objects are often described in this disclosure as stored in ‘lists’ such as the exemplary security control object lists (318), it is also well within the scope of the present invention to store security control objects or references to security control objects in sets, arrays, linked lists, and other data structures as will occur to those of skill in the art.

According to the exemplary class relations of FIG. 4, concrete security control classes (315) also are associated by reference with translator factories (634). As described above in this disclosure, security control objects instantitated from concrete security control classes, by calling factory methods such as, for example, createTranslatorObject( ) (636), obtain and store within them references to translator object instantiated from concrete translator classes (638). The arrow (632) can be drawn between concrete security control classes (315) and concrete translator classes (638), indicating that a security control class ‘has a’ translator class, because the reference needed to implement the object oriented ‘has a’ relationship is provided to the security control class by a translator factory (634).

Again referring to FIG. 2, the illustrated method includes deploying (226) a security object. Security objects can be created (206) on a client device and deployed (226) to a client device (102), including the same client device on which the security object is created, or to a server (106). Security objects can be created (206) on a server and deployed (226) to a server (106), including the same server on which the security object is created, or to a client device (102). Deployment can be local, that is, within the same client device or server, or within a trusted IAN.

Deployment can be remote, that is, across public networks, such as, for example, the Internet or the World Wide Web. One advantageous mode of remote deployment, for example, is a download of a security object implemented as a Java applet to a Java-enabled web browser. An applet is a Java program designed to be run from another program, such as a browser, rather than directly from an operating system. Because applets typically are small in file size, cross-platform compatible, and highly secure (can't be used to access users' hard drives), they are useful for small Internet applications accessible from a browser, including for example, security objects according to the present invention.

More particularly, in some embodiments according to the method of FIG. 2, a resource (112) resides on a resource server (110), and the method includes deploying (226) the security object (108) on a security server (106) and receiving (208) the request for access to the resource in a security server (106) from a client device (102) across a network (202). Network (202), as mentioned above, can be any network, public or private, local area or wide area, wireless or wired. In embodiments according to this aspect of the invention, receiving (208) a request for access (210) is typically carried out through some form of remote procedure call, such as, for example, a hyperlink to a Java servlet, a hyperlink to a CGI function, a call to a member method in a CORBA object, a remote object call through a Java RMI interface, or a remote object call through a DCOM interface.

In a further aspect of the method of FIG. 2, a resource (112) resides on a client device (102), and the client device has an application program (120 on FIG. 1c) that accesses the resource. In this kind of embodiment, the method includes deploying (226) the security object (108) on the client device (102), effecting an architecture like the one shown in FIG. 1c. In this configuration, receiving (208) a request (210) for access to the resource (112) includes receiving (208) the request for access to the resource in the security object itself as a call to the security method (218). In some embodiments of this kind, in fact, a security object (108) can be compiled right into the client application (120), so that receiving a request for access is implemented as a conventional local function call, with no particular need for remote procedure calling methodologies such as those listed above—hyperlinks, CORBA, Java RMI, and so on.

In some embodiments of the present invention receiving (208) a request for access (210) to a resource (112) comprises a call to a security method (218) in a security object (108). Such direct calls can be implemented through Java, for example, by naming the security method (218) ‘main( )’ and issuing a call of the form java SecurityObjectName.’ Alternatively, a call may be issued from a hyperlink in a browser to a security method in a security object implemented as a Java servlet by including in an HTTP request message a URI of the form:

http://ServerName/servlet/MySecurityObject

where MySecurityObject is the name of a security object implemented as a servlet and containing a security method named according to the conventions of the standard Java servlet interface, that is, for example, named ‘service( ).’

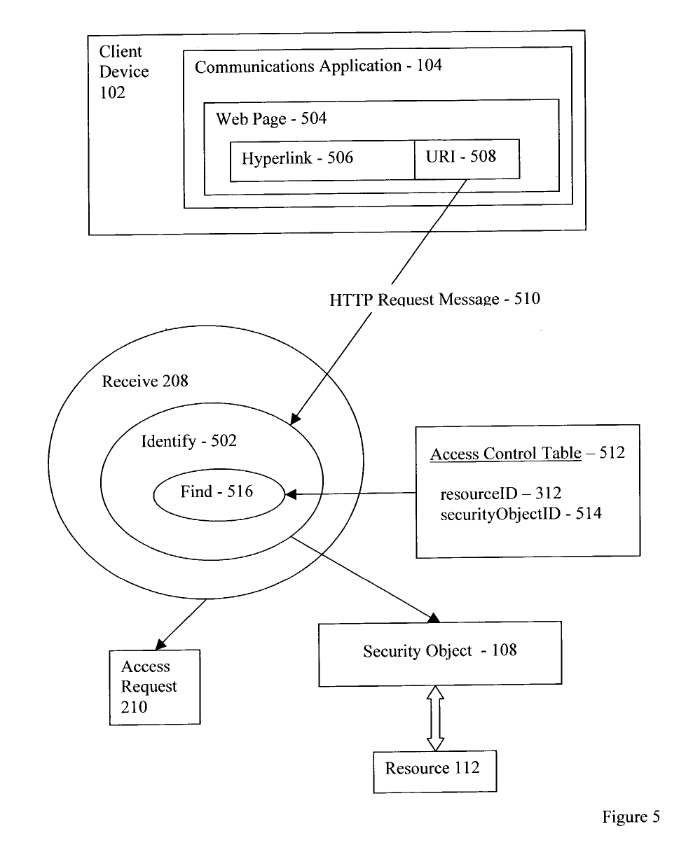

FIG. 5 sets forth a data flow diagram illustrating more detailed embodiments of receiving (208) a request (210) for access to a resource. In one method according to FIG. 5, receiving (208) a request (210) for access to a resource (112) includes identifying (502) a security object (108), that is, identifying a security object that controls access to the resource. Consider the example mentioned earlier of a security object (108) implemented as a Java servlet. In such an exemplary embodiment, identifying (502) the security object (108) comprises identifying the security object in dependence upon a URI (508). Typically, the URI (508) originates from a hyperlink (506) in a web page (504) in a communications application (104) in a client device (102). The communications application can be, for example, a browser in a client device that is a personal computer or a microbrowser in a client device that is a web-enabled cell phone. Such embodiments typically communicate the identification of the security object in the form of an HTTP request message containing the URI. The URI can have this form:

http://ServerName/servlet/MySecurityObject

from which a servlet-enabled server can invoke the security object as a servlet named MySecurityObject. The server does not invoke the security object in the sense of calling it as such. The server ‘invokes’ the security object in that the server calls a member method within the security object according to the conventions of the standard Java servlet interface. In this example, the identity of the security object was known to the calling application.

It is possible, however, that the calling application may know the identity of a resource without knowing the identity of the security object that controls access to the resource. In such an exemplary embodiment, a request for access to a secured resource may arrive in an HTTP request directed at a resource that is a document identified as:

http://ServerName/SomeoneElsesFiles/Document123.

For use in such embodiments, in one method according to FIG. 5, identifying (502) the security object (108) includes identifying the security object in dependence upon a URI (508) that identifies the resource (112), including finding (516), in dependence upon the URI (508) identifying the resource (112), an identification (514) of the security object in an access control table (512).

Although in this example, where the access request came with a URI, the identification (312) of the resource is, for example, a URI or a filename or pathname extracted from a URI. In embodiments of the invention generally, there is no requirement that the communications application be a browser or use HTTP for its communications. The resource identification (312) can be any digital identification, including for example, a filename or pathname communicated in a plaintext string or in cyphertext.

The identification (514) of the security object can be the security object name, for example, or, in the example where the security object is implemented as a Java servlet, the identification (514) of the security object can be a URI in the now familiar form:

http://ServerName/servlet/MySecurityObject.

In this kind of embodiment, a security server is programmed upon receiving a request for access, to check an access control table (512). In fact, this small change in the overall programming of the security server, is the only thing that makes it a 'security server’ within the meaning of the present invention. The security server needs no other security-related service upon it. Security authentication and authorization are handled by the security object. All the security server needs to do is look up the identity of the security object and invoke it. ‘Invoke’ in this sense means to call the security method in the security object by, for example, a call to ‘java SecurityObjectName’ for a security object implemented as a standard Java class, a call to ‘http://ServerName/servlet/MySecurityObject’ for a security object implemented as a Java servlet, or a call to ‘SecurityObjectName’ for a security object implemented as a C++ program. If the security server can find no security object for the resource identified in a request for access, then the security server continues its normal operations. If the security server is programmed to grant access only upon finding a corresponding security object, then the security server denies access when no such object is found in the access control table. If the security server has other security services available upon it, then it is often programmed to apply them in its usual fashion.

Alternatively, if the security server has no other security services available upon it, it may be programmed to comply with HTTP request messages on their own terms according to whether they are GET messages, PUT messages, and so on. In other words, the security server can implement the standard operations of a web server. This implementation is a little riskier than the other two examples mentioned just above but it has the advantage of being very easy to implement, requiring as it does only one small change to the source code of a conventional web server just to do one lookup in an access control table and, if the lookup succeeds, invoke a security object identified in the lookup.

By this point in this disclosure, several advantages of using various embodiments of the present invention are clear. One advantage is pure flexibility, especially at the user level and the application level. Embodiments of the present invention can make foundry applications available to ordinary users, rather then just to system administrators. Any user can choose to associate with any resource any kind of security data supported in a security system. Users can decide for themselves whether they want just a plain text logon ID and/or something much more elaborate—a fingerprint, a voiceprint, a retinal scan, and so on. As a result, users can be given great freedom in defining the security content and security level for securing users' resources, much greater freedom than available to users in prior art systems.

Another advantage of security objects according to the present invention is that security servers, communications servers, resource servers such as document or application servers—none of the servers in networks need to have any particular concern with security beyond associating a security object with a resource. Moreover, as mentioned above, it is possible within the present invention to establish a regime in which all resources in a particular location are accessed only indirectly through security objects, in which case, a server providing access to such resources need have upon it no other security service whatsoever, at least as regards authentication and authority level. In particular, servers that administer access to resources need not be concerned with the type of security data provided by users or required to qualify for access to a resource.

Another advantage of the present invention relates to encryption. As described above, certain elements of security control data are advantageously stored in encrypted form. Persons seeking unauthorized access to resources may seek to decrypt such security control data. Such unauthorized access is made much more difficult by a need, easily established by any properly authorized user, to decrypt not only a single security control data element such as a password, but also to decrypt multiple security control data elements including fingerprints, retinal scans, voiceprints, and so on.

Another advantage of the present invention is the ease with which a user can arrange multiple access authorization for multiple users. A user authorized to do so, under the present invention, can simply create multiple security objects for a single resource and distribute, for example, a URI identifying each such separate security object to separate users. By such usage, a user can quickly grant with respect to a particular document, for example, ‘read’ access to Jane Smith, ‘read’ access to Joe Blow, ‘write’ access to Mike Walker, and reserve ‘execute’ access to the original user, the owner of the document. The security control data can be set differently in each of the separate security objects all of which point to the same document, therefore preventing Jane and Joe from using Mike's security object to gain access, even if they can gain access to Mike's security object.

Another advantage is reduction of security responsibility on the part of server system administrators. This advantage obtains because security objects of the present invention tend to upcast security control from communications protocols layers to application layers. “Layers” in this context refers to the standard data communications protocol stack in which the IP protocol resides in layer 3, the so called ‘network layer,’ and the Transmission Control Protocol, or ‘tcp,” resides in layer 4, the so called transport layer. In this context, SSL is considered a layer 4 security protocol, and the well known protocol for virtual private networking known as “IPSec” is considered a layer 3 protocol. In this disclosure, any functionality above layer 4 is described as residing in an ‘application layer.’ Therefore security objects according to the present invention are considered to be application layer software. As such, security objects and their operations in securing access to resources are completely transparent to systems administrators working on layer 4 or layer 3 security systems. In fact, it is possible to structure web servers as security servers, as mentioned above, so that such security servers have little or no concern regarding whether layer 4 or layer 3 security systems even exist at all. This is potentially a dramatic shift in security responsibilities for system administrators, including, for example, system administrators in Internet Service Providers or ‘ISPs.’

Another advantage is that foundries can be implemented in many languages, so that a user can interact with a foundry in the user's native language. Still, such foundries, regardless of the native language, can implement security control objects having security control passwords that are compared, after translation, with security request passwords in any supported language.

It will be understood from the foregoing description that various modifications and changes may be made, and in fact will be made, in the exemplary embodiments of the present invention without departing from its true spirit. The descriptions in this specification are for purposes of illustration only and are not to be construed in a limiting sense. The scope of the present invention is limited only by the language of the following claims.

What is claimed is:

1. A method of controlling access to a resource, the method comprising.
creating a security object in dependence upon user-selected security control data types, the security object comprising security control data and at least one security method, the security control data including a security control password in a security control language;
receiving a request for access to the resource;
receiving security request data, the security request data including a security request password in a security request language, the security request language being a language other than the security control language; and
determining access to the resource in dependence upon the security control data and the security request data.

2. The method of claim 1 wherein creating a security object further comprises:
storing in the security object a resource identification for the resource;
storing in the security object user-selected security control data types, including a security control data type for a password with language translation; and
storing, in the security object, security control data for each user-selected security control data type, including the security control password and an identification of the security control language.

3. The method of claim 2 wherein storing security control data includes storing an identification of the security request language.

4. The method of claim 2 wherein storing security control data includes storing an indication whether the security request password comprises speech.

5. The method of claim 1 wherein the security request password comprises speech and receiving security request data includes converting a security request password from speech to text.

6. The method of claim 1 wherein determining access to the resource includes translating a security request password from the security request language to the security control language.

7. A system for controlling access to a resource, the system comprising:
means for creating a security object in dependence upon user-selected security control data types, the security object comprising security control data and at least one security method, the security control data including a security control password in a security control language;
means for receiving a request for access to the resource;
means for receiving security request data, the security request data including a security request password in a security request language, the security request language being a language other than the security control language; and
means for determining access to the resource in dependence upon the security control data and the security request data.

8. The system of claim 7 wherein means for creating a security object further comprises:
means for storing in the security object a resource identification for the resource;
means for storing in the security object user-selected security control data types, including a security control data type for a password with language translation; and
means for storing, in the security object, security control data for each user-selected security control data type, including the security control password and an identification of the security control language.

9. The system of claim 8 wherein means for storing security control data includes means for storing an identification of the security request language.

10. The system of claim 8 wherein means for storing security control data includes means for storing an indication whether the security request password comprises speech.

11. The system of claim 7 wherein the security request password comprises speech and means for receiving security request data includes means for converting a security request password from speech to text.

12. The system of claim 7 wherein means for determining access to the resource includes means for translating a security request password from the security request language to the security control language.

13. A computer program product for controlling access to a resource, the computer program product comprising:
a recording medium;
means, recorded on the recording medium, for creating a security object in dependence upon user-selected security control data types, the security object comprising security control data and at least one security method, the security control data including a security control password in a security control language;
means, recorded on the recording medium, for receiving a request for access to the resource;
means, recorded on the recording medium, for receiving security request data, the security request data including a security request password in a security request language, the security request language being a language other than the security control language; and
means, recorded on the recording medium, for determining access to the resource in dependence upon the security control data and the security request data.

14. The computer program product of claim 13 wherein means for creating a security object further comprises:
means, recorded on the recording medium, for storing in the security object a resource identification for the resource;
means, recorded on the recording medium, for storing in the security object user-selected security control data types, including a security control data type for a password with language translation; and
means, recorded on the recording medium, for storing, in the security object, security control data for each user-selected security control data type, including the security control password and an identification of the security control language.

15. The computer program product of claim 14 wherein means for storing security control data includes means, recorded on the recording medium, for storing an identification of the security request language.

16. The computer program product of claim 14 wherein means for storing security control data includes means, recorded on the recording medium, for storing an indication whether the security request password comprises speech.

17. The computer program product of claim 13 wherein the security request password comprises speech and means for receiving security request data includes means, recorded on the recording medium, for converting a security request password from speech to text.

18. The computer program product of claim 13 wherein means for determining access to the resource includes means, recorded on the recording medium, for translating a security request password from the security request language to the security control language.
